(19) United States
(12) Patent Application Publication
(10) Pub. No.: US 2016/0007285 A1
(43) Pub. Date: Jan. 7, 2016

(54) APPARATUS FOR SUPPORTING POWER-SAVING FOR WIRELESS REPEATER AND METHOD THEREOF

(71) Applicant: DAVOLINK INC., Anyang-si, Gyeonggi-do (KR)

(72) Inventors: Youn-Geun JEON, Seongnam-si (KR); Jong-Moon CHOI, Anyang-si (KR); Young-Ho PARK, Gunpo-si (KR)

(73) Assignee: DAVOLINK INC., Gyeonggi-do (KR)

(21) Appl. No.: 14/435,885

(22) PCT Filed: Mar. 29, 2013
(86) PCT No.: PCT/KR2013/002615

§ 371 Date: Apr. 15, 2015

(30) Foreign Application Priority Data
Mar. 25, 2013 (KR) 10-2013-0031483

(51) Int. Cl. H04W 52/02; H04B 7/155

(52) U.S. Cl. CPC H04W 52/0219; H04B 7/15507; H04W 52/0206

(57) ABSTRACT

Provided are an apparatus for supporting power-saving for a wireless repeater and a method thereof. The apparatus for supporting power-saving for the wireless repeater includes: an information receiving unit that receives information regarding adjacent wireless repeaters from each of peripheral wireless repeaters; a group forming unit that forms groups of wireless repeaters based on the information regarding adjacent wireless repeaters received by the information receiving unit; a leader setting unit that sets a leader in the group of wireless repeaters formed by the group forming unit; and a mode providing unit that provides a power-saving mode to the remaining wireless repeaters except for the wireless repeater as the leader by the leader setting unit among the groups of wireless repeaters formed by the group forming unit.

### TECHNICAL FIELD

The present invention relates to an apparatus for supporting power-saving for a wireless repeater and a method thereof, and more particularly, to an apparatus for supporting power-saving for a wireless repeater, in which virtual groups of peripheral wireless repeaters are formed in an environment in which Institute of Electrical and Electronics Engineers (IEEE) 802.11a/b/g/n/ac wireless repeaters are installed and an optimum power-saving mode for each wireless repeater is provided based on the formed groups, and a method thereof.

### BACKGROUND ART

As wireless communication services using mobile phones or smartphones have recently expanded, installation of wireless repeaters that relay wireless services between wireless terminal equipment and a server has also been increased.

However, these wireless repeaters do not always relay the wireless services to the wireless terminal equipment. Thus, when a wireless repeater does not relay a wireless service, the wireless repeater needs to be converted into a power-saving mode and to effectively manage wireless resources in consideration of a service time of the wireless repeater and an allocation amount of the wireless resources.

In general, management of power-saving for the wireless repeater is performed in such a way that a plurality of wireless repeaters are set to a group and a manager for himself/herself sets each wireless repeater in a power-saving mode.

However, in a method of managing power-saving for the wireless repeater, even in the wireless repeater that belongs to the same group, the wireless repeater installed at a long distance has a limitation in the manager's management, and it is difficult to effectively manage the wireless resources for each wireless repeater.

### PRIOR-ART DOCUMENT

### Patent Document

(Patent document 1) Korean Patent Laid-open Publication No. 10-2004-0051408 (published on Jun. 18, 2004)

### DETAILED DESCRIPTION OF THE INVENTION

### Technical Problem

The present invention provides an apparatus for supporting power-saving for a wireless repeater, in which virtual groups of peripheral wireless repeaters are formed in an environment in which Institute of Electrical and Electronics Engineers (IEEE) 802.11a/b/g/n/ac wireless repeaters are installed and an optimum power-saving mode for each wireless repeater is provided based on the formed groups, and a method thereof.

### Technical Solution

According to an aspect of the present invention, there is provided an apparatus for supporting power-saving for a wireless repeater, including: an information receiving unit that receives information regarding adjacent wireless repeaters from each of peripheral wireless repeaters; a group forming unit that forms groups of wireless repeaters based on the information regarding adjacent wireless repeaters received by the information receiving unit; a leader setting unit that sets a leader in the group of wireless repeaters formed by the group forming unit; and a mode providing unit that provides a power-saving mode to the remaining wireless repeaters except for the wireless repeater as the leader by the leader setting unit among the groups of wireless repeaters formed by the group forming unit.

The information receiving unit may receive information from peripheral wireless repeaters in a cycle set based on an initial time.

The group forming unit may form wireless repeaters among the peripheral wireless repeaters, communication of which are connected to each other, as the same group.

The apparatus may further include a weighted value assignment unit that assigns a weighted value to each of the peripheral wireless repeaters according to the number of adjacent wireless repeaters, wherein the leader setting unit may set wireless repeaters each having the uppermost weighted value within a group based on the weighted value assigned by the weighted value assignment unit as a leader.

The apparatus may further include a comparing unit that sequentially compares receiving sensitivities and noise of the corresponding wireless repeaters when two or more wireless repeaters each having the uppermost weighted value in the same group are present, wherein the leader setting unit may set a leader in the same group based on at least one of the receiving sensitivities and noise compared by the comparing unit.

The apparatus may further include a selective operation setting unit that sets wireless repeaters each having the lowermost weighted value in the group as a selective operation wireless repeater based on the weighted value assigned by the weighted value assignment unit when the number of wireless repeaters in the groups formed by the group forming unit is equal to or greater than a set value.

The comparing unit may sequentially compare the receiving sensitivities and noise of the wireless repeaters when two or more wireless repeaters each having the lowermost weighted value in the same group are present, and the selective operation setting unit may set a selective operation wireless repeater in the same group based on at least one of the receiving sensitivities and noise compared by the comparing unit.

The mode providing unit may provide the same operation mode as the wireless repeater set as the leader to the wireless repeater set as the selective operation wireless repeater set by the selective operation setting unit.

According to another aspect of the present invention, there is provided a method of supporting power-saving for a wireless repeater performed by an apparatus for supporting power-saving for the wireless repeater, including: receiving information regarding adjacent wireless repeaters from each of peripheral wireless repeaters; forming groups of wireless repeaters based on the information regarding adjacent wireless repeaters received in the receiving of the information; setting a leader in the group of wireless repeaters formed in the forming of the groups; and providing a power-saving mode to the remaining wireless repeaters except for the wireless repeater as the leader by the leader setting unit among the groups of wireless repeaters formed in the forming of the groups.

The receiving of the information may include receiving information from the peripheral wireless repeaters in a cycle set based on an initial time.

The forming of the groups may include forming wireless repeaters among the peripheral wireless repeaters, communication of which are connected to each other, as the same group.

The method may further include assigning a weighted value to each of the peripheral wireless repeaters according to the number of adjacent wireless repeaters, wherein the setting of the leader may include setting wireless repeaters each having the uppermost weighted value within a group based on the weighted value assigned in the assigning of the weighted value as a leader.

The method may further include sequentially comparing receiving sensitivities and noise of the corresponding wireless repeaters when two or more wireless repeaters each having the uppermost weighted value in the same group are present, wherein the setting of the leader may include setting a leader in the same group based on at least one of the compared receiving sensitivities and noise.

The method may further include setting wireless repeaters each having the lowermost weighted value in the group as a selective operation wireless repeater based on the weighted value assigned in the assigning of the weighted value when the number of wireless repeaters in the groups formed in the forming of the groups is equal to or greater than a set value.

The method may further include sequentially comparing the receiving sensitivities and noise of the wireless repeaters when two or more wireless repeaters each having the lowermost weighted value in the same group are present, and the setting of the selective operation may include setting a selective operation wireless repeater in the same group based on at least one of the compared receiving sensitivities and noise.

The providing of the power-saving mode may include providing the same operation mode as the wireless repeater set as the leader to the wireless repeater set as the selective operation wireless repeater set in the setting of the selective operation.

### DESCRIPTION OF THE DRAWINGS

FIG. 1 is a view for describing the concept of an apparatus for supporting power-saving for a wireless repeater, according to an embodiment of the present invention;

FIG. 2 is a view of an example in which virtual groups of wireless repeaters illustrated in FIG. 1 are formed;

FIG. 3 is a view of a configuration of the apparatus for supporting power-saving for a wireless repeater, according to an embodiment of the present invention;

FIG. 4 is a view of information regarding adjacent wireless repeaters, which are received from each of peripheral wireless repeaters;

FIGS. 5 through 8 are views for describing an operation of forming groups based on the information illustrated in FIG. 4 and setting a leader in a group;

FIG. 9 is a view for describing an example in which a selective operation wireless repeater is set, when the number of wireless repeaters in the group is equal to or greater than a set value; and

FIG. 10 is a flowchart illustrating a method of supporting power-saving for a wireless repeater, according to an embodiment of the present invention.

### BEST MODE

Hereinafter, an apparatus for supporting power-saving for a wireless repeater and a method thereof according to exemplary embodiments of the present invention will be described in detail with reference to the attached drawings.

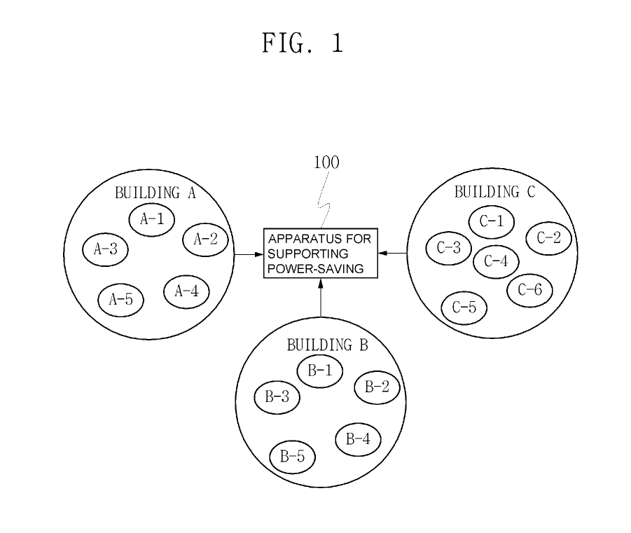

FIG. 1 is a view for describing the concept of an apparatus for supporting power-saving for a wireless repeater, according to an embodiment of the present invention.

An apparatus 100 for supporting power-saving for a wireless repeater, according to an embodiment of the present invention may receive information regarding adjacent wireless repeaters from each of peripheral wireless repeaters in a set cycle and may form virtual groups of wireless repeaters based on the received information.

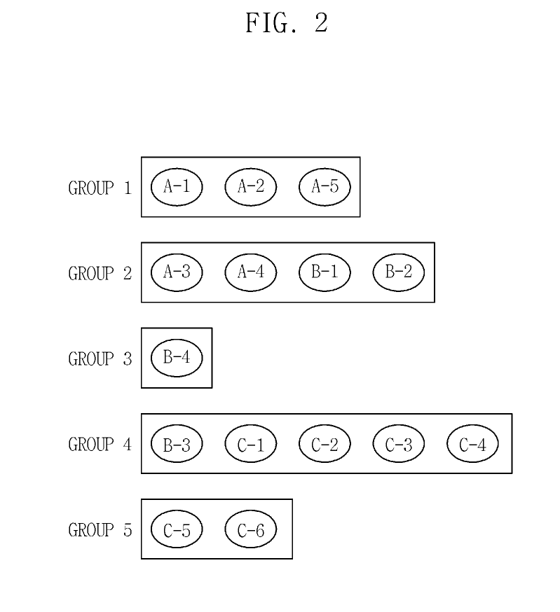

For example, as illustrated in FIG. 1, it is assumed that building A, building B, and building C exist in the periphery of the apparatus 100 for supporting power-saving, wireless repeaters A-1, A-2, A-3, A-4, and A-5 are installed in building A, wireless repeaters B-1, B-2, B-3, and B-4 are installed in building B, and wireless repeaters C-1, C-2, C-3, C-4, and C-5 are installed in building C. In this case, the apparatus 100 for supporting power-saving may form new virtual groups of wireless repeaters, as illustrated in FIG. 2, based on the information regarding the adjacent wireless repeaters, which are received from each wireless repeater, regardless of the position of each wireless repeater. The operation of forming the virtual groups using the apparatus 100 for supporting power-saving for the wireless repeater will be described later.

The apparatus 100 for supporting power-saving for the wireless repeater may manage a power-saving mode operation based on a time section, a date section, or a service history. For example, the apparatus 100 for supporting power-saving for the wireless repeater may operate the power-saving mode operation by setting a night particular time zone in which a wireless repeater service using the wireless repeater is hardly carried out, or by inputting a particular date, such as a holiday or a public holiday. Also, when a wireless local area network (LAN) service history of the wireless repeater for wireless terminal equipment is not present for a predetermined time, the apparatus 100 for supporting power-saving for the wireless repeater may operate the power-saving mode operation in a corresponding service time zone. Management of the power-saving mode operation may be set by a manager.

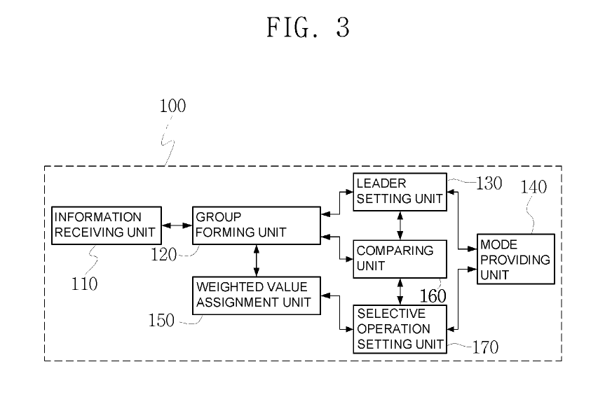

FIG. 3 is a view of a configuration of the apparatus for supporting power-saving for a wireless repeater, according to an embodiment of the present invention.

Referring to FIG. 3, the apparatus 100 for supporting power-saving for the wireless repeater, according to the current embodiment of the present invention may include an information receiving unit 110, a group forming unit 120, a leader setting unit 130, a mode providing unit 140, a weighted value assignment unit 150, a comparing unit 160, and a selective operation setting unit 170.

The information receiving unit 110 receives the information regarding the adjacent wireless repeaters from each of peripheral wireless repeaters. In this case, the information receiving unit 110 may receive information regarding the adjacent wireless repeaters from each of peripheral wireless repeaters using time set based on an initial time as a cycle. For example, when the apparatus 100 for supporting power-saving is booted or reset or the manager sets a reference time, the information receiving unit 110 may receive the information regarding the adjacent wireless repeaters from each of peripheral wireless repeaters at predetermined time intervals from a particular time after booting or resetting or the set reference time. Here, the information regarding the adjacent wireless repeaters that is information regarding the wireless repeater that is capable of performing wireless communication when one wireless repeater is capable of performing wireless communication with at least one wireless repeater, includes identification information regarding the wireless repeater.

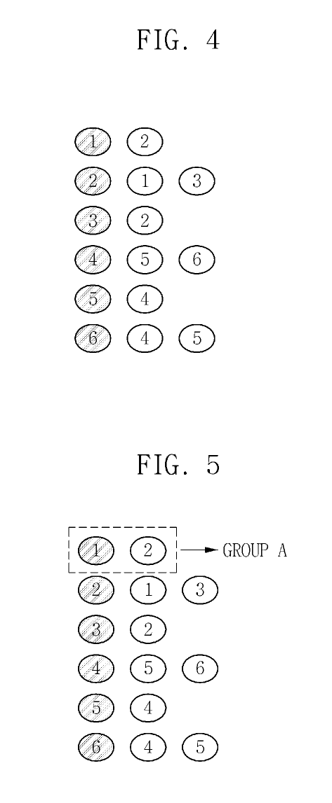

For example, when wireless repeaters 1, 2, 3, 4, 5, and 6 exist in the periphery of the apparatus 100 for supporting power-saving for the wireless repeater, according to the current embodiment of the present invention, the information receiving unit 110 may receive the information regarding the adjacent wireless repeaters illustrated in FIG. 4 from each wireless repeater. Here, numbers indicated by deviant crease lines represent wireless repeaters that transmit the information regarding the adjacent wireless repeaters, and numbers having no deviant crease lines represent identification information regarding the adjacent wireless repeaters transmitted by the wireless repeater indicated on an end of the left side. That is, information received from wireless repeater 1 indicates that wireless repeater 1 is capable of performing wireless communication with wireless repeater 2, and information received from wireless repeater 2 indicates that wireless repeater 2 is capable of performing wireless communication with wireless repeater 1 and wireless repeater 3, and information received from wireless repeater 3 indicates that wireless repeater 3 is capable of performing wireless communication with wireless repeater 2. This also applies to cases of wireless repeaters 4 through 6.

The group forming unit 120 forms groups of wireless repeaters based on information regarding the wireless repeater received by the information receiving unit 110. In this case, the group forming unit 120 may form wireless repeaters, wireless communication of which is connected to each other, as the same group based on the information received from each wireless repeater.

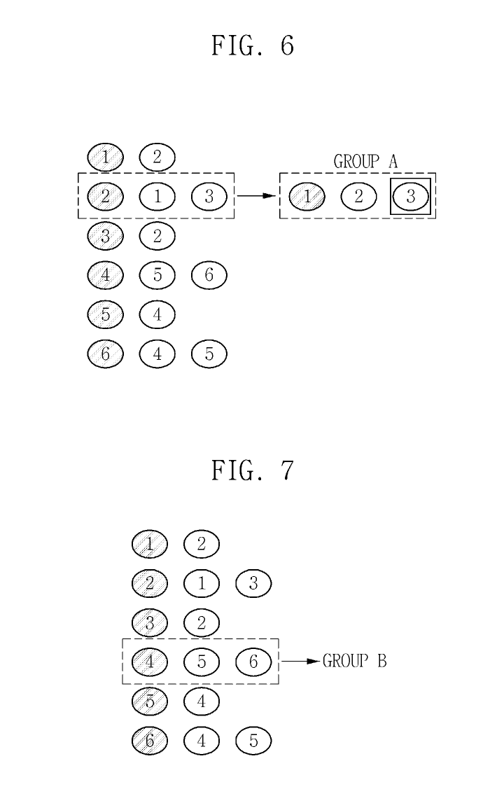

When the information regarding the adjacent wireless repeaters for each wireless repeater received by the information receiving unit 110 is as illustrated in FIG. 4, the group forming unit 120 may allocate wireless repeater 1 and wireless repeater 2, wireless communication of which is connected to wireless repeater 1, as group A, as illustrated in FIG. 5. Also, the group forming unit 120 may correct the allocated group A based on information regarding the adjacent wireless repeaters, which are received from wireless repeater 2, i.e., information regarding the wireless repeater that is capable of performing wireless communication with wireless repeater 2, as illustrated in FIG. 6. That is, since the information regarding the adjacent wireless repeaters received from wireless repeater 2 is wireless repeater 1 and wireless repeater 3, the group forming unit 120 may correct group A by adding wireless repeater 3 to the already-allocated group A. Also, when the group forming unit 120 refers to the information regarding the wireless repeaters received from wireless repeater 3, all of the adjacent wireless repeaters are included in group A and thus, group A is maintained without any change.

Meanwhile, when the group forming unit 120 refers to the information regarding the adjacent wireless repeaters received from wireless repeater 4, wireless repeaters, wireless communication of which are connected to wireless repeater 4, are wireless repeater 5 and wireless repeater 6 and are irrelevant to wireless repeaters in group A. Thus, wireless repeater 4, wireless repeater 5, and wireless repeater 6 may be allocated as group B for a new wireless repeater, as illustrated in FIG. 7. In this manner, by referring to the information regarding the adjacent wireless repeaters received from wireless repeater 5 and wireless repeater 6, the formed group B is wireless repeater 4, wireless repeater 5, and wireless repeater 6 and is maintained without any change.

In the same way, the group forming unit 120 may form groups of two wireless repeaters of group A and group B with respect to the information regarding the adjacent wireless repeaters illustrated in FIG. 4.

The leader setting unit 130 sets a leader in the group for the wireless repeater formed by the group forming unit 120. For example, with respect to the information regarding the adjacent wireless repeaters illustrated in FIG. 4, the leader setting unit 130 may set each leader for group A and group B formed by the group forming unit 120.

The mode providing unit 140 may provide a power-saving mode to the remaining wireless repeaters except for wireless repeaters set as leaders by the leader setting unit 130 among groups of wireless repeaters formed by the group forming unit 120. That is, the mode providing unit 140 may maintain a power supply mode of each wireless repeater in a group in an optimum state by transiting the remaining wireless repeaters except for the wireless repeaters set as leaders by the leader setting unit 130 into the power-saving mode.

The weighted value assignment unit 150 assigns a weighted value to each wireless repeater in the group based on the number of adjacent wireless repeaters. For example, information regarding the adjacent wireless repeaters is as illustrated in FIG. 4, the weighted value assignment unit 150 may assign weighted value 1 to wireless repeater 1, because the number of adjacent wireless repeaters is 1, and may assign weighted value 2 to wireless repeater 2 in the same manner. In this case, since the weighted value of wireless repeater 2 is uppermost among weighted values of wireless repeaters in group A formed by the group forming unit 120, the leader setting unit 130 may set wireless repeater 2 to a leader of group A.

Meanwhile, in group B formed based on the information regarding the adjacent wireless repeaters illustrated in FIG. 4, the number of adjacent wireless repeaters for wireless repeater 4 is 2 and thus, similarly, the number of adjacent wireless repeaters for wireless repeater 6 is 2. Thus, two or more wireless repeaters within a group may have the same uppermost weighted value.

In this case, the comparing unit 160 may sequentially compare receiving sensitivities and noise of the wireless repeaters having the same uppermost weighted value in the group, and the leader setting unit 130 may set a leader in the group based on at least one of the receiving sensitivities and noise compared by the comparing unit 160. For example, when receiving sensitivity of wireless repeater 4 with respect to wireless repeater 6 in the above-described group B is −60 and receiving sensitivity of wireless repeater 6 with respect to wireless repeater 4 is −40, the leader setting unit 130 may set wireless repeater 6 having good receiving sensitivity in group B as a leader in group B. If the receiving sensitivity of wireless repeater 4 and the receiving sensitivity of wireless repeater 6 are the same, the leader setting unit 130 may set wireless channel noise of each wireless repeater and may set a wireless repeater having less measured noise as a leader.

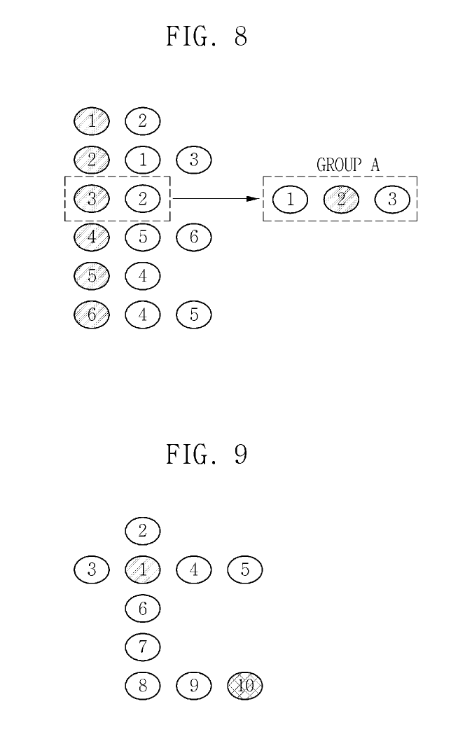

FIG. 9 is a view for describing an example in which a selective operation wireless repeater is set, when the number of wireless repeaters in a group is equal to or greater than a set value.

As illustrated in FIG. 9, when the number of wireless repeaters in the group formed by the group forming unit 120 is equal to or greater than a set value, the selective operation setting unit 170 may set a wireless repeater having the lowermost weighted value in the group as a selective operation wireless repeater based on weighted values assigned by the weighted value assignment unit 150. Here, the selective operation wireless repeater is a wireless repeater that operates in the same operation mode as the wireless repeater set as the leader in the corresponding group. The reason why the selective operation setting unit 170 sets the wireless repeater having the lowermost weighted value in the group as the selective operation wireless repeater, is that wireless communication connection between the wireless repeater having the uppermost weighted value in the group and the wireless repeater having the lowermost weight in the group is most unstable as the result of experiments. In this case, when two or more wireless repeaters having the lowermost weight in the same group are present, the comparing unit 160 may sequentially compare receiving sensitivities and noise of respective wireless repeaters each having the lowermost weighted value, and the selective operation setting unit 170 may set a selective operation wireless repeater in the same group based on at least one of the receiving sensitivities and noise compared by the comparing unit 160.

In FIG. 9, since a wireless repeater having the uppermost weighted value in a group including wireless repeaters 1 through 10 is wireless repeater 1, the leader setting unit 130 may set wireless repeater 1 as a leader. Also, the selective operation setting unit 170 may set wireless repeater 10 having the weakest receiving sensitivity and being farthest from wireless repeater 1 set as the leader among wireless repeater 2, wireless repeater 3, wireless repeater 5, and wireless repeater 10 each having the lowermost weighted value in the group. In this case, the mode providing unit 140 may operate wireless repeater 1 set as the leader and wireless repeater 10 set as the selective operation wireless repeater in the same operation mode and may transit the remaining wireless repeaters in the group into a power-saving mode. Preferably, the mode providing unit 140 may maintain wireless outputs of the wireless repeater set as the leader and the wireless repeater set as the selective operation wireless repeater in a maximum state and may transit the remaining wireless repeaters in the group into the power-saving mode.

As described above, even when the apparatus 100 for supporting power-saving for the wireless repeater operates in the power-saving mode, if services for wireless terminal equipment start being carried out, the apparatus 100 for supporting power-saving for the wireless repeater releases the power-saving mode operation and performs services for wireless terminal equipment. That is, when there is a request of wireless LAN services from the wireless terminal equipment, the leader or selective operation wireless repeater in the group may transmit request signals for the corresponding services to the apparatus 100 for supporting power-saving and may release the power-saving mode for the other wireless repeaters in the corresponding group.

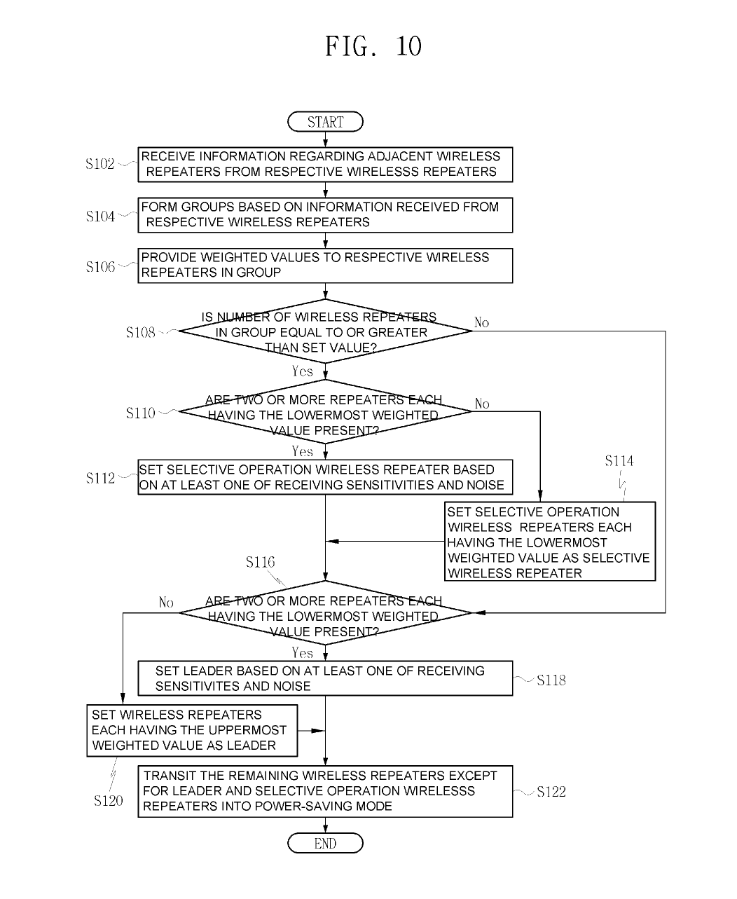

FIG. 10 is a flowchart illustrating a method of supporting power-saving for a wireless repeater, according to an embodiment of the present invention.

Referring to FIGS. 1 through 10, the apparatus 100 for supporting power-saving receives information regarding adjacent wireless repeaters from peripheral wireless repeaters (S102).

The apparatus 100 for supporting power-saving forms groups of wireless repeaters, wireless connection of which is connected to each other, based on the information regarding adjacent wireless repeaters, which are received from each wireless repeater (S104).

In this case, the apparatus 100 for supporting power-saving may assign weighted values based on the number of wireless repeaters that are capable of performing wireless communication of respective wireless repeaters in the group (S106).

When the number of wireless repeaters in the same group is equal to or greater than a set value (S108), the apparatus 100 for supporting power-saving may set a wireless repeater having the lowermost weighted value as a selective operation wireless repeater (S114). In this case, if the number of wireless repeaters each having the lowermost weighted value is two or more (S110), receiving sensitivities and noise of wireless repeaters each having the lowermost weighted value are compared with at least one of receiving sensitivities and noise of wireless repeaters each having the uppermost weighted value and thus, a one selected wireless repeater having the lowermost weighted value may be set as the selective operation wireless repeater (S112).

Here, the number of wireless repeaters in the group that is a base for setting the selective operation wireless repeater may be set by the manager overall in consideration of receiving sensitivity and noise of each wireless repeater in the corresponding group and a distance between respectively wireless repeaters.

The apparatus 100 for supporting power-saving sets wireless repeaters each having the uppermost weighted value in the group as a leader in the group (S120). When two or more wireless repeaters having the uppermost weighted value in the group are present (S116), the apparatus 100 for supporting power-saving may set a one selected wireless repeater having the uppermost weighted value as a leader based on at least one of receiving sensitivities and noise of the wireless repeaters (S118).

Here, in the drawings, the selective operation wireless repeater has been first set and then the leader has been set. However, the operation is not necessarily performed in the above order, and practically, an operation of determining a leader in the group may be first performed and then, an operation of determining whether the selective operation wireless repeater is set and a setting operation thereof may be performed.

The apparatus 100 for supporting power-saving operates the wireless repeaters by transiting the remaining wireless repeaters except for wireless repeaters set as the leader in the group and the selective operation wireless repeater into a power-saving mode and operates the wireless repeaters by changing wireless outputs of the wireless repeaters set as the leader and the selective operation wireless repeater in a maximum state (S122).

If there is a request of wireless services from the wireless terminal equipment, the power-saving mode is terminated when the wireless repeater set as the leader or the selective operation wireless repeater releases the power-saving mode of the remaining wireless repeaters in the group.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

As described above, according to the present invention, virtual groups of peripheral wireless repeaters can be formed, and an optimum power-saving mode can be provided to respective wireless repeaters based on the formed groups in real time.

In addition, according to the present invention, since an apparatus for supporting power-saving operates conditions in which respective wireless repeaters are released from the power-saving mode, in units of group, respective wireless repeaters do not need to be transited into a general mode from the power-saving mode so as to restart wireless services. Thus, the power-saving mode can be effectively operated.

1. An apparatus for supporting power-saving for a wireless repeater, the apparatus comprising:
an information receiving unit that receives information regarding adjacent wireless repeaters from each of peripheral wireless repeaters;
a group forming unit that forms groups of wireless repeaters based on the information regarding adjacent wireless repeaters received by the information receiving unit;
a leader setting unit that sets a leader in the group of wireless repeaters formed by the group forming unit; and
a mode providing unit that provides a power-saving mode to the remaining wireless repeaters except for the wireless repeater as the leader by the leader setting unit among the groups of wireless repeaters formed by the group forming unit.

2. The apparatus of claim 1, wherein the information receiving unit receives information from peripheral wireless repeaters in a cycle set based on an initial time.

3. The apparatus of claim 1, wherein the group forming unit forms wireless repeaters among the peripheral wireless repeaters, communication of which are connected to each other, as the same group.

4. The apparatus of claim 2, further comprising a weighted value assignment unit that assigns a weighted value to each of the peripheral wireless repeaters according to the number of adjacent wireless repeaters,
wherein the leader setting unit sets wireless repeaters each having the uppermost weighted value within a group based on the weighted value assigned by the weighted value assignment unit as a leader.

5. The apparatus of claim 4, further comprising a comparing unit that sequentially compares receiving sensitivities and noise of the corresponding wireless repeaters when two or more wireless repeaters each having the uppermost weighted value in the same group are present,
wherein the leader setting unit sets a leader in the same group based on at least one of the receiving sensitivities and noise compared by the comparing unit.

6. The apparatus of claim 5, further comprising a selective operation setting unit that sets wireless repeaters each having the lowermost weighted value in the group as a selective operation wireless repeater based on the weighted value assigned by the weighted value assignment unit when the number of wireless repeaters in the groups formed by the group forming unit is equal to or greater than a set value.

7. The apparatus of claim 6, wherein the comparing unit sequentially compares the receiving sensitivities and noise of the wireless repeaters when two or more wireless repeaters each having the lowermost weighted value in the same group are present, and
the selective operation setting unit sets a selective operation wireless repeater in the same group based on at least one of the receiving sensitivities and noise compared by the comparing unit.

8. The apparatus of claim 7, wherein the mode providing unit provides the same operation mode as the wireless repeater set as the leader to the wireless repeater set as the selective operation wireless repeater set by the selective operation setting unit.

9. A method of supporting power-saving for a wireless repeater performed by an apparatus for supporting power-saving for the wireless repeater, the method comprising:
receiving information regarding adjacent wireless repeaters from each of peripheral wireless repeaters;
forming groups of wireless repeaters based on the information regarding adjacent wireless repeaters received in the receiving of the information;
setting a leader in the group of wireless repeaters formed in the forming of the groups; and
providing a power-saving mode to the remaining wireless repeaters except for the wireless repeater as the leader by the leader setting unit among the groups of wireless repeaters formed in the forming of the groups.

10. The method of claim 9, wherein the receiving of the information comprises receiving information from the peripheral wireless repeaters in a cycle set based on an initial time.

11. The method of claim 9, wherein the forming of the groups comprises forming wireless repeaters among the peripheral wireless repeaters, communication of which are connected to each other, as the same group.

12. The method of claim 10, further comprising assigning a weighted value to each of the peripheral wireless repeaters according to the number of adjacent wireless repeaters,
wherein the setting of the leader comprises setting wireless repeaters each having the uppermost weighted value within a group based on the weighted value assigned in the assigning of the weighted value as a leader.

13. The method of claim 12, further comprising sequentially comparing receiving sensitivities and noise of the corresponding wireless repeaters when two or more wireless repeaters each having the uppermost weighted value in the same group are present,
wherein the setting of the leader comprises setting a leader in the same group based on at least one of the compared receiving sensitivities and noise.

14. The method of claim 13, further comprising setting wireless repeaters each having the lowermost weighted value in the group as a selective operation wireless repeater based on the weighted value assigned in the assigning of the weighted value when the number of wireless repeaters in the groups formed in the forming of the groups is equal to or greater than a set value.

15. The method of claim 14, further comprising sequentially comparing the receiving sensitivities and noise of the wireless repeaters when two or more wireless repeaters each having the lowermost weighted value in the same group are present, and
the setting of the selective operation comprises setting a selective operation wireless repeater in the same group based on at least one of the compared receiving sensitivities and noise.

16. The method of claim 15, wherein the providing of the power-saving mode comprises providing the same operation mode as the wireless repeater set as the leader to the wireless repeater set as the selective operation wireless repeater set in the setting of the selective operation.
